(19) United States
(12) Patent Application Publication
(10) Pub. No.: US 2011/0066302 A1
(43) Pub. Date: Mar. 17, 2011

(54) INTELLIGENT ENERGY-SAVING SYSTEM AND METHOD

(76) Inventor: John Arthur McEwan, Alexandria, VA (US)

(21) Appl. No.: 12/561,063

(22) Filed: Sep. 16, 2009

(51) Int. Cl. G06F 1/32

(52) U.S. Cl. 700/295

(57) ABSTRACT

A system for controlling energy-related characteristics of a building includes at least one energy-related device that determines a first energy-related condition and a second energy-related condition in a specified interior area of a building. The first energy-related condition corresponds to a use of energy that has a greater efficiency than the second energy-related condition. A controller is coupled to the at least one energy-related device and receives information relating to the use of the at least one energy-related device. The controller operates the at least one energy-related device to transition between the first energy-related condition and the second energy-related condition according to at least one user-specified input and the information relating to the use of the at least one energy-related device. At least one sensor may provide a signal indicating the information relating to the use of the at least one energy-related device.

### BACKGROUND OF THE INVENTION

1. Field of the Invention

The invention pertains to the field of energy conservation and, more particularly, to systems and methods for intelligently changing energy-related characteristics of areas in a building.

2. Description of Related Art

People have become increasingly concerned about issues relating to the use of natural energy resources. In particular, increasing demand for energy to fuel worldwide economic development has recently strained fossil fuel supplies and caused significant increases in the cost of fossil fuels. In addition, the burning of fossil fuels results in carbon emissions that are believed to contribute to global climate change. Accordingly, economic interests and concern over damage to the environment has generated interest in ways to reduce consumption of fossil fuels and to find other sources of energy.

Demand for fossil fuel supplies results in part from energy consumption in people's homes. For example, natural gas may be burned to heat a house during cold seasons, while oil or coal may be burned to produce electricity to cool the house during warm seasons. A house consumes more energy when heat is able to escape from the house interior during the cold seasons or when heat is able to enter the house interior during warm seasons. Insulation and sealing may be used to minimize energy transfer through the walls and small openings in the house. However, energy inefficiencies may still result when energy is allowed to transfer, for example, through the windows in the house. While coverings may be applied to the windows to minimize this energy transfer, such coverings may prevent the windows from fulfilling their intended function, i.e., providing a view of an area outside the house to its occupants or allowing light into the interior of the house. Thus, making a house more energy efficient is met with various challenges. In particular, other needs of the occupants of the house must be balanced against the goal of improving energy efficiency.

### SUMMARY OF THE INVENTION

In view of the foregoing, embodiments according to aspects of the present invention provide systems and methods for managing energy consumption while also meeting other needs of the occupants of the building. For example, in some embodiments, coverings for windows in a house are intelligently controlled to improve energy efficiency while allowing the occupants to see out of the windows and/or allowing light into the interior of the house when desired.

In an example embodiment, a system for controlling energy-related characteristics of a building includes at least one energy-related device that determines a first energy-related condition and a second energy-related condition in a specified interior area of a building. The first energy-related condition corresponds to a use of energy that has a greater efficiency than the second energy-related condition. A controller is coupled to the at least one energy-related device and receives information relating to the use of the at least one energy-related device. The controller operates the at least one energy-related device to transition between the first energy-related condition and the second energy-related condition according to at least one user-specified input and the received information relating to the use of the at least one energy-related device.

In some embodiments, at least one sensor provides a signal indicating the information relating to the use of the at least one energy-related device. The at least one sensor may include at least one subject sensor providing a subject-sensor signal indicating a position of at least one subject relative to the specified interior area, where the controller operates the at least one energy-related device according to the position of the at least one subject. In addition, the at least one sensor may include at least one environmental sensor providing an environmental-sensor signal indicating an environmental condition related to the specified interior area of the building, where the controller operates the at least one energy-related device according to the environment-sensor signal from the at least one environmental sensor. Additionally or alternatively, input data which the controller uses to operate the at least one energy-related device may be obtained from non-sensor information sources.

These and other aspects of the present invention will become more apparent from the following detailed description of the preferred embodiments of the present invention when viewed in conjunction with the accompanying drawings.

### BRIEF DESCRIPTION OF THE DRAWINGS

FIG. 1A illustrates a state of an interior of a building with an embodiment of an intelligent window covering system according to aspects of the present invention.

FIG. 1B illustrates another state of the interior of the building of FIG. 1A.

FIG. 1C illustrates yet another state of the interior of the building of FIG. 1A.

FIG. 2 illustrates an interior of a building with another embodiment of an intelligent window covering system according to aspects of the present invention.

FIG. 3 illustrates yet another embodiment of an intelligent window covering system according to aspects of the present invention.

FIG. 4 illustrates an intelligent energy saving system according to aspects of the present invention.

### DETAILED DESCRIPTION

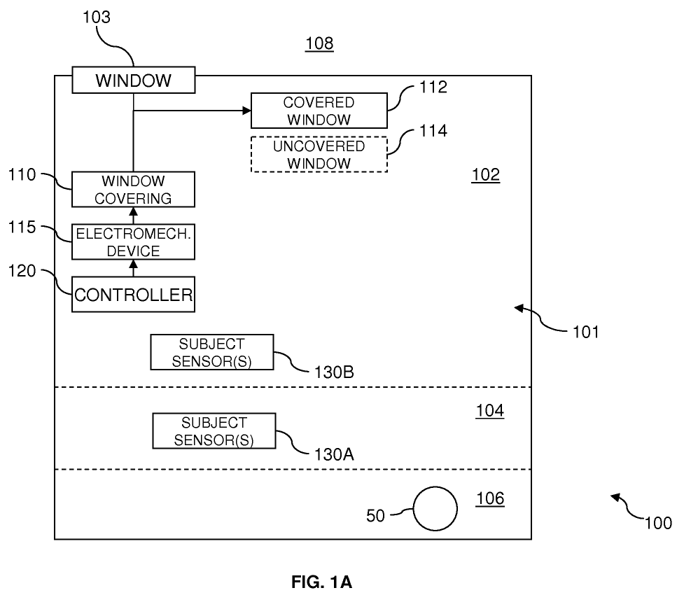

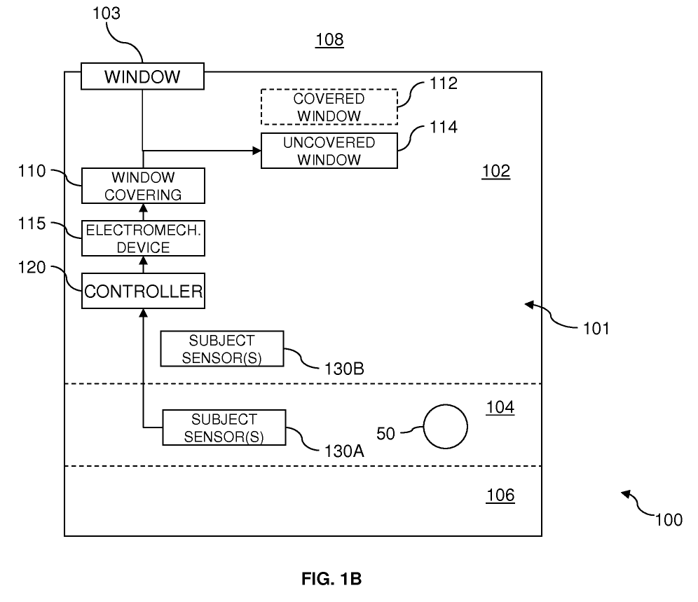

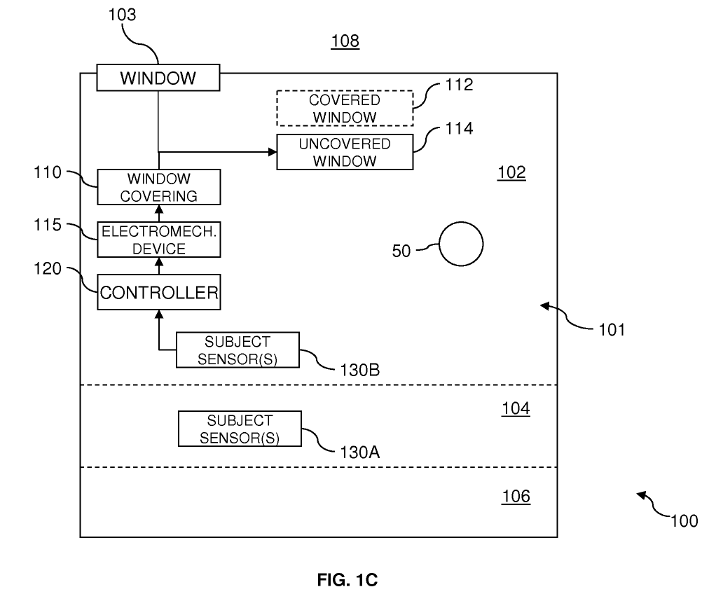

Referring to FIGS. 1A-C, an example system 100 according to aspects of the present invention is illustrated. In particular, FIGS. 1A-C shows an interior 101 of a building, such as a house, which is divided into a plurality of areas 102, 104, 106. The area 102 in this example, for instance, is an interior room 102 of the building. The room 102 includes a window 103 and a corresponding window covering 110. The window covering 110 may be operated to determine whether the window 103 is a covered window 112 or an uncovered window 114. As illustrated in FIG. 1A, for example, the window 103 is a covered window 112. Although the example system 100 may be described in terms of the window 103 and the window covering 110 in the room 102, it is understood that the features of the system 100 are applicable to any number of windows and window coverings in any number of rooms or areas of the building. Moreover, it is understood that the term window as used herein may refer to any structure that permits some light transmission or radiation heat transfer to occur through a portion of the structure. As such, the window 103 may be a glass door, a skylight, or the like.

The window covering 110 may include window blinds, drapes, shutters, fabric, and/or any barrier that can cover or uncover the window 103 from the interior or exterior. In the example of FIGS. 1A-C, when the window is covered by the window covering 110, the window covering 110 provides thermal insulation over the window 103 and reduces heat transfer between the room 102 and an exterior area 108 outside the building and the window 103. In addition, the window covering 110 may provide a barrier to the passage of air, e.g., a draft, through, or around, parts of the window 103, and thus further reduces heat transfer between the room 102 and the exterior area 108. If, for example, the room 102 is being heated to keep the room 102 warm during a cold day, the covered window 112 reduces the amount of interior heat that escapes from the room 102 through the window 103, resulting in a more efficient use of the energy to heat the room 102. On the other hand, if the room 102 is being air conditioned to keep the room 102 cool during a warm day, the covered window 112 reduces the amount of exterior heat that enters the room 102 through the window 103, resulting in a more efficient use of the energy to cool the room 102. Thus, the covered window 112 produces a first energy condition that corresponds to a more efficient use of energy within the room 102.

However, when the window 103 is not covered by the window covering 110, the window covering 110 does not reduce the heat transfer through the window 103. For example, with the uncovered window 114, interior heat may escape from the room 102 through the window 103 when the room 102 is being heated during a cold day, or exterior heat may enter the room 102 through the window 103 when the room 102 is being cooled during a warm day. Accordingly, the uncovered window 114 produces a second energy condition that corresponds to a less efficient use of energy within the room 102.

Although the covered window 112 provides advantages with regard to energy efficiency, the window covering 110 may prevent the window 103 from fulfilling its intended function, i.e., allowing occupants 50 in the room 102 to see the exterior area 108 or allowing exterior light into the room 102. Indeed, the occupants 50 may prefer to sacrifice energy efficiency in favor of seeing through the window 103 or allowing exterior light into the room 102. Thus, according to aspects of the present invention, the system 100 selectively operates the window covering 110 to achieve the appropriate balance between improving energy efficiency in the room 102 and accommodating the preferences of its occupants 50. In general, aspects of the present invention provide an intelligent system 100 that accounts for the occupants 50 in the interior 101 of the building when selecting between a more efficient energy condition, e.g., the covered window 112, and a less efficient energy condition, e.g., the uncovered window 114.

When the occupants 50 are in the room 102, their preferences may require the uncovered window 114, but when there are no occupants in the room 102, the system 100 can cover the window 103 to maximize the use of energy in the room 102. Thus, as shown in FIGS. 1A-C, the system 100 employs a controller 120 to intelligently control the operation of the window covering 110 according to the position of one or more occupants 50 relative to the room 102. The controller 120, in some embodiments, may operate the window covering 110 by sending a signal to an electromechanical device 115 that is coupled to the window covering 110 and causes movement of the window covering 110 to provide the covered window 112 or the uncovered window 114. For example, the controller 120 may send an actuating signal to one or more motors that cause the window covering 110, such as blinds, to open and close over the window 103.

As discussed previously, the interior 101 may be divided into a plurality of areas 102, 104, and 106. The area 106 may represent any area of the building where the occupants 50 cannot see the windows in the room 102 and are not affected by the operation of the window covering 110. When the occupants 50 are situated in the area 106 and there are no occupants 50 in the room 102, as shown in FIG. 1A, the controller 120 may be programmed to operate the window covering 110 to cover the window and maximize energy efficiency in the room 102.

Meanwhile, the area 104 may represent any area, such as a hallway, that is proximate to and leads to the room 102. When an occupant 50 is situated in the area 104 as shown in FIG. 1B, the controller 120 may determine that the occupant 50 is approaching the room 102. In particular, one or more subject sensors 130A corresponding to the area 104 may be employed to detect the physical presence of the occupant 50 in the area 104. The subject sensors 130A may include any combination of motion sensors, heat sensors, tactile sensors, pressure sensors, cameras, and any other device that may detect that the occupant 50 has entered or is positioned in the section 104. In some cases, an active signal from the subject sensors 130A indicates the presence of an occupant 50, while the absence of any signal indicates that an occupant 50 is not present. The subject sensors 130A may be coupled to the controller 20 by a wired or wireless (e.g., radio frequency (RF), infrared (IR) light, etc.) connection, so that the subject sensors 130A can send the controller 120 a signal indicating the presence of the occupant 50 in the section 104. Alternatively, electrically detectable identification tags, such as radio frequency identification (RFID) tags, may be attached to each occupant 50, and the subject sensor 130A may determine the position and movement of each occupant 50 with respect to the room 102. The subject sensors 130A may include RFID receivers positioned through the interior 101, a global positioning system (GPS), or the like.

In one example, the subject sensors 130A may be arranged so that the signals from the subject sensors 130A may indicate that the occupant 50 is moving toward the room 102. One approach employs a series of subject sensors 130A that are arranged at incremental distances from an entrance to the room 102, so that the signals from the subject sensors 130A can indicate the distance of the occupant 50 from the room 102. In this approach, signals indicating decreasing distance also indicates that the occupant is moving closer to the room 102. In another example, the subject sensors 130A may include one or more cameras which may capture images that can be processed to determine the motion of the occupant 50 in the area 104.

When the controller 120 receives signals from the subject sensors 130A corresponding to the room 104, it may operate the window covering 110 to uncover the window 103 before the occupant 50 actually enters the room 102. Accordingly, as shown in FIG. 1C, when the occupant 50 enters the room 102, the window 103 is already uncovered. In other words, the operation of the window covering 102 is not apparent to the occupant 50 and the occupant 50 can enter the room 102 and immediately see through the window 103. As discussed previously, the uncovered window 140 may be less energy efficient by allowing unwanted heat transfer through the window, but may make the room 102 more suitable for the needs or preferences of the occupants 50 by allowing the occupants 50 to see out the window or allowing exterior light into the room 102.

As shown further in FIGS. 1A-C, one or more subject sensors 130B corresponding to the room 102 may also be coupled to the controller 120 by a wired or wireless (e.g., radio frequency (RF), infrared (IR) light, etc.) connection. The subject sensors 130B send signals to the controller 120 to indicate that occupants 50 are in the room 102. As long as occupants 50 remain in the room 102, the controller 120 keeps the windows uncovered. Like the subject sensors 130A, the subject sensors 130B may involve any combination of motion sensors, heat sensors, tactile sensors, weight sensors, force sensors, cameras, electrically detectable identification tags, and any other device that may detect that the occupant 50 has entered or is positioned in the room 102.

Once the occupant 50 leaves the room 102 and the area 104, the controller 120 receives corresponding indication from the subject sensors 130A and 130B. In response, the controller 120 may then operate the window covering 110 to cover the window 103 and make the use of energy in the room more efficient.

In other embodiments, the subject sensors 130A corresponding to the area 104 are not employed. Instead, the controller 120 may be programmed to operate the window covering 110 when the one or more subject sensors 130B in the room 102 detects the occupant 50. Although the operation of the window covering 110 is apparent to the occupant 50, the end result is the same, i.e., the window is uncovered for the occupant 50.

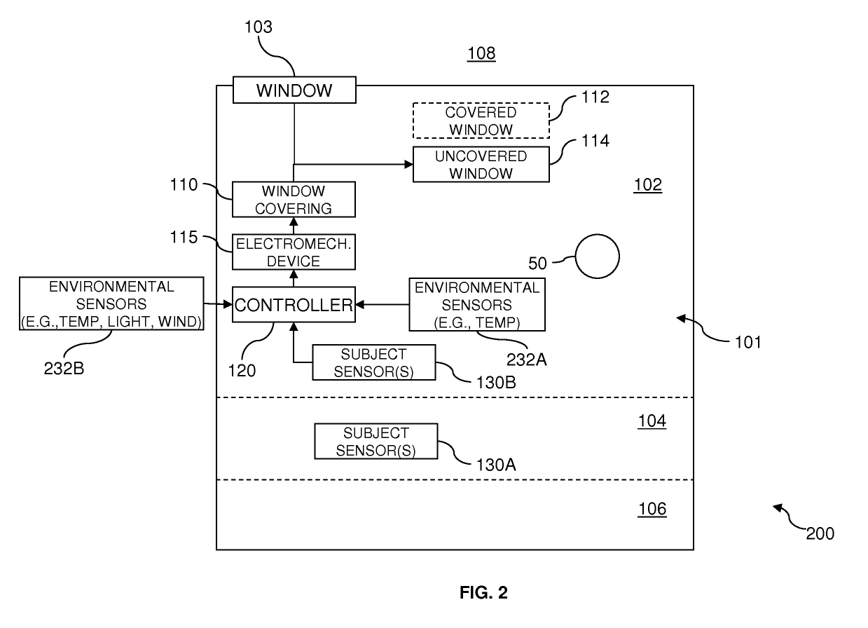

The system 100 provides just one example embodiment employing aspects of the present invention. For example, the inputs to the controller 120 are not limited to the use of subject sensors 130A and 130B that detect the position of occupants 50 in the building. Referring to FIG. 2, the system 200 is similar to the system 100 described previously, except the controller 120 is also coupled to one or more environmental sensors 232A corresponding to the room 102 and one or more environmental sensors 232B corresponding to the exterior area 108. The environmental sensors 232A and 232B provide signals that provide information that the controller 120 may also use to determine whether the window covering 110 should be operated to cover or uncover the window 103.

For example, the environmental sensors 232A and 232B may indicate the temperature in the room 102 and the exterior area 108, respectively. Receiving the temperature data from the environmental sensors 232A and 232B, the controller 120 may determine that the temperature in the room 102 is significantly higher than the temperature of the exterior area 108 on a cold day. On the other hand, the controller 120 may determine that the temperature in the room 102 is significantly lower than the temperature of the exterior area 108 on a warm day. In other words, the controller 120 may determine that there is a large temperature difference between the room 102 and the exterior area 108, which may result in greater heat transfer through the uncovered window 103. Thus in both cases, if there are no occupants 50 in the room 102 requiring the window 103 to remain uncovered, the controller 120 may be programmed to cover the window 103 to prevent unwanted heat transfer through the window 103 as described previously.

However, receiving the temperature data from the environmental sensors 232A and 232B, the controller 120 may determine that the temperature difference between the room 102 and the exterior area 108 may be relatively small. In this case, the heat transfer through the window 103 may be relatively insignificant. As a result, whether or not there are occupants 50 in the room 102, the controller 120 may leave the window 103 uncovered without any significant loss in energy efficiency, and unnecessary operation of the window covering 110 may be avoided. In many cases, it may be preferable to leave the window 103 uncovered as much as possible. For example, a building with covered windows may not be aesthetically pleasing and may appear unwelcoming. In addition, the covered window 114 may block outside light from entering the room 102, and although the room 102 may not have occupants 50, other areas of the interior 101 may receive some light from the room 102. Indeed, allowing outside light to enter the interior 101 may reduce the need for artificial lighting that also consumes energy. To determine whether the temperature difference is large enough to require covering the window 103 to conserve energy, the controller 120 may be programmed with a temperature difference threshold to indicate when covering the window 103 may appreciably improve energy efficiency.

In addition, the controller 120 may be programmed with a desired temperature parameter that indicates an interior temperature that is comfortable for the occupants 50. Indeed, the controller 120 may be coupled to a thermostat used by the heating, ventilation, and air conditioning (HVAC) for the room 102, so that the controller 120 may determine the desired temperature parameter from the HVAC system and operate the window covering 110 in concert with the HVAC system. (The thermostat can also provide the temperature sensor 232A.) Thus, if the temperature of room 102 is sufficiently close to the desired temperature parameter, the controller 120 may operate according to the temperature difference as described previously. However, in some cases, the controller 120 may determine that the temperature of the room 102 may be higher than the desired temperature parameter and the temperature may be lowered more quickly by permitting heat transfer through the window to the exterior area 108 which is at a lower temperature. For instance, the sunlight may suddenly enter the room 102 and cause the temperature in the room 102 to increase faster than the heating system can react. Conversely, the controller 120 may determine that the temperature of the room 102 may be lower than the desired temperature parameter and the temperature may be increased more quickly by permitting heat transfer through the window from the exterior area 108 which is at a higher temperature. For instance, sunlight entering the room may suddenly cease and cause the temperature in the room 102 to decrease faster than the air conditioning can react. In general, as described further below, a variety of thresholds, parameters, and other data may be provided as input to the controller 120 to allow more intelligent operation of window covering 110.

The environmental sensors 232A and 232B are not limited to providing temperature data. For example, the environmental sensors 234B in the room 102 may also include humidity sensors that detect the amount of humidity within the room 102. Humidity may also determine the level of comfort in the room 102. For example, greater humidity may make a given temperature less comfortable. Thus, in some embodiments, the controller 120 may operate according to humidity measurements in combination with temperature measurements. In particular, the desired temperature parameter may be adjusted to account for humidity, e.g., lowered when there is high humidity. In addition, as described previously, the controller 120 may operate the window covering 110 in concert with a HVAC system to reduce the humidity in addition to lowering the temperature.

As a further example, the environmental sensors 232B in the exterior area 108 may also include light sensors that detect the amount of sunlight directed at the window 103. The sunlight entering the room 102 may affect the temperature of the room 102 through radiation heat transfer. In addition, the occupants may prefer to have natural sunlight in the room 102. Moreover, as described earlier, allowing outside light to enter the interior 101 may reduce the need for artificial lighting that also consumes energy. As the window covering 110 affects the amount of outside light that enters the room 102, the controller 120 may further receive signals from these light sensors to determine whether the window 103 should be covered or uncovered.

For example, although temperature sensors may indicate that the temperature in the exterior area 108 is very low and that there is a large temperature difference between the room 102 and the exterior area 108, light sensors may indicate that a significant amount of sunlight is directed at the window 103. In this case, the amount of heat delivered into the room 102 by the sunlight may be greater than the amount of heat that escapes from the room 102 through the window 103. As such, the controller 120 may be programmed to leave the window 103 uncovered. If the temperature sensors in the room 102 indicate that the room 102 exceeds the desired temperature parameter, the controller 120 may be programmed to incrementally cover the window until the appropriate amount of sunlight enters the room 102. Indeed, although the window 103 may be described as being covered or uncovered, it is understood that the window covering 110 may be operated to partially cover the window 103 in varying degrees so that the system is not limited to two energy conditions.

Conversely, when the environmental sensors 232A and 232B indicate that the amount of sunlight is insufficient to overcome the amount of heat that escapes from the room 102 through the window 103, e.g., when the sun sets, the controller 120 may be programmed to cover the window 103.

However, in other cases, temperature sensors may indicate that the temperature in the exterior area 108 is very high and that there is a large temperature difference between the room 102 and the exterior area 108. As such, energy may be consumed to keep the room 102 cool, and any heat introduced into the room 102 by sunlight should be minimized. As a result, the controller 120 may be programmed to cover the window 103.

As described previously, the room 102 may include more than one window and the controller 120 may control more than one window covering. As the windows may be arranged to face different directions from the building, each window may receive a different amount of sunlight. The amount of light received by each window may be detected by a corresponding light sensor. Therefore, the controller 120 may leave some windows covered and other windows uncovered depending on the signal from each corresponding light sensor. For example, on a cold day, a window facing the sun may be uncovered to allow the sunlight to warm the room 102, while a window on the opposite side of the room may be covered because it is receiving an insignificant amount of sunlight.

The light sensors may also indicate when the sun has set and the night has arrived. During the night, the occupants may see very little through the window 103. In this case, the controller 120 may be programmed to cover the window 103 even though an occupant 50 is in the room 102. In other words, the benefit to the occupant 50 by uncovering the window 103 may not outweigh the loss of energy efficiency, because the occupant may not be able to see anything through the window 103. In addition, keeping the window 103 covered during the night may enhance security and privacy as the room 102 may be more visible through the window 103 from the exterior when the room 102 is lighted in the night.

According to aspects of the present invention, the external environmental sensors 232B are not limited to temperature or light sensors. For example, additionally or alternatively, the environmental sensors 232B may include a wind sensor that detects wind in the exterior area 108 proximate to the window 103. Wind acting in the area of the window 103 may cause convention cooling and thus heat transfer between the exterior area 108 and the room 102 via the window 103. The controller 120 may operate the window covering 110 at least partially according to signals from the wind sensors. As described previously, the window covering 110 may provide a barrier to the passage of air, e.g., a draft, through, or around, parts of the window 103, and thus further reduces heat transfer between the room 102 and the exterior area 108.

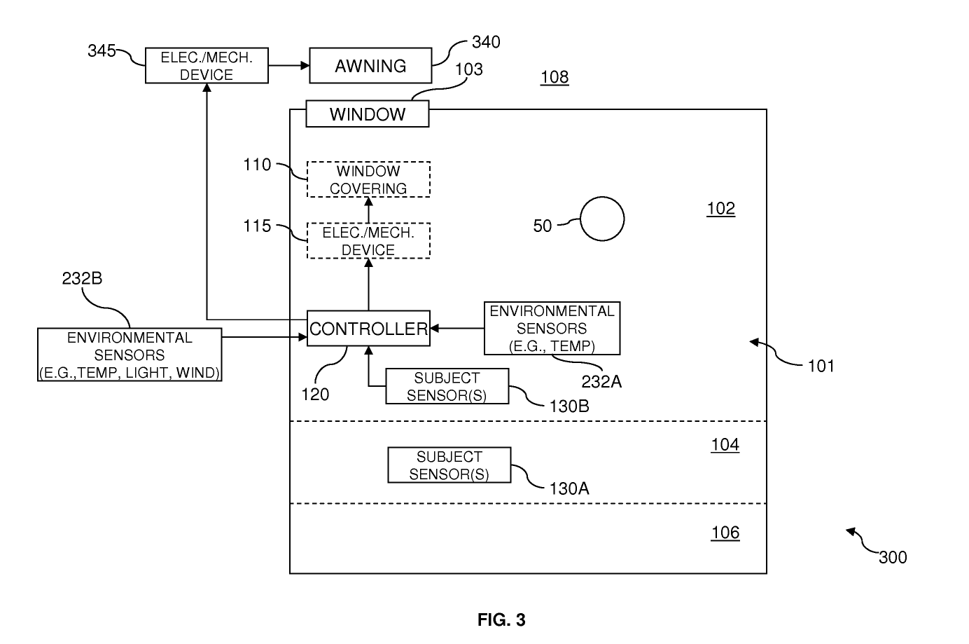

Although the systems 100 and 200 illustrate the use of the window covering 110, embodiments according to the present invention are not limited to the use of the window covering 110. As shown in FIG. 3, a system 300 employs an awning 340 that extends from the building exterior over the window 103. Although aspects of the awning 340 may be similar to the window covering 110, the awning 340 typically controls the entry of sunlight into the room 102 and may provide less thermal insulation over the window. Furthermore, the awning 340 may not completely prevent occupants 50 from seeing the exterior area 108 through the window. As shown in FIG. 3, the awning 340 may be employed in combination with the window covering 110.

As described previously, the environmental sensors 232B in the exterior area 108 may include light sensors that detect the amount of sunlight directed at the window 103. These sensors provide a signal to the controller 120, and the controller 120 may be programmed to respond by extending or retracting the awning 340. The controller 120, in some embodiments, may operate the awning 340 by sending a signal to an electromechanical device 345 that is coupled to the awning 340 and causes movement of the awning 340 to provide an extended awning 112 or a retracted awning 114. For example, the controller 120 may send an actuating signal to one or more motors that cause the awning 340 to extend from the building exterior over the window 103.

Accordingly, if the light sensors indicate that a significant amount of sunlight is directed at the window 103 on a cold day, the controller 120 may be programmed to retract the awning 340 completely, so that the maximum amount of sunlight may enter the room 102 through the window 103 and heat the room 102. If temperature sensors in the room 102 indicate that the room 102 exceeds the desired temperature parameter, e.g., set at a thermostat, the controller 120 may be programmed to incrementally extend the awning 340 until the appropriate amount of sunlight enters the room 102.

On the other hand, if the light sensors indicate that a significant amount of sunlight is directed at the window 103 on a warm day, the controller 120 may be programmed to extend the awning 340 over the window 103 to reduce the amount of sunlight entering the room 102. If the window 103 is not covered, for example by the window covering 110, some indirect light and a view through the window 103 is advantageously provided, but the heating effect of the sunlight is minimized.

Because the sun moves with respect to the window 103, the sunlight approaches the window 103 from different angles. In response, the controller 120 may be programmed to extend or retract the awning 340 incrementally according to the position of the sun. For example, if the window 103 is generally facing west, the angle between the direction of the sunlight and the surface of the window 103 approaches 90-degrees as the afternoon passes. Thus, the controller 120 may extend the awning 340 increasingly from the building to prevent the sunlight from directly passing through the window. At some point, the angle may be too great, i.e., as the sun reaches the horizon, for the awning 340 to be effective. In this case, the system 300 may employ the window covering 110 to cover the window 103 and block the sunlight.

According to aspects of the present invention, embodiments are not limited to the use of the window covering 110 and/or the awning 340. For example, an electrically activated window tinting may be employed to provide a barrier to the passage of light through the window 103. In response to signals from light sensors, for instance, the controller 120 may send a signal to cause the appropriate level of tinting in the window 103. Advantageously, the window tinting can provide a barrier to sunlight regardless of the position of the sun, in contrast to the use of the awning 340 which may require the additional use of the window covering 110 when the sun is at particular angles to the window 103.

As discussed previously, the controller 120 can receive a variety of data as input to provide more intelligent systems. For example, rather than employing light sensors to determine the amount of sunlight reaching the window 103, the controller 103 in some embodiments may estimate the amount of sunlight through input data that indicates the movement of the sun relative to the window 103. The amount of sunlight can be estimated, for example, by considering the time of year, the time of day, geographical location, the known movement of the sun, and the direction in which the window 103 faces.

Indeed, in some embodiments, sensors are not required to provide all of the information that the controller 120 uses as input to operate the window covering 110, awning 340, and other similar barriers. For example, rather than employing subject sensors 130A or 130B to determine the presence of an occupant 50, embodiments may require the occupant 50 to manually indicate his presence in an area by operating a switch on a wall or other similar device that delivers an informational signal to the controller 120. As another example, rather than employing environmental sensors 232B, information regarding environmental conditions in the exterior area 108 may be determined by accessing information that has been collected by another source. For example, weather information that may affect the operation of the window covering 110, awning 340, and other similar barriers may be retrieved from an Internet website or networked service that dynamically monitors and reports weather that affects the exterior area 108. Meanwhile, other environmental information, such as the estimated amount of sunlight described previously, may be more easily pre-determined, and thus may be pre-programmed or pre-loaded into a repository, such as a database, which can be accessed by the controller 120. In general, the controller 120 may receive input from sensors, non-sensor information sources, or any combination thereof. In some cases, the information from the sensors may be validated by information from non-sensor sources.

Although the controller 120 may automatically operate the window covering 110, the awning 340, and other barriers in response to signals from sensors, the controller 120 may be programmed or instructed to override the automated response in certain situations. For example, the occupants 50 may prefer to have the window 103 uncovered during a particular period of the day regardless of what the sensors may indicate and what the energy cost may be. In another example, the occupants 50 may prefer to have the window 103 covered even if there are occupants 50 in the room, e.g., to preserve privacy and security at night. Thus, the controller 120 intelligently accounts for a variety of user preferences.

The response of the controller 120 can also be determined according to other exceptional situations. The controller 120 may operate the window covering 110, the awning 340, or other similar barrier according to other activities or occurrences in or around the building. For example, the controller 120 may operate the window covering 110 to respond to signals from a security system which detects the presence of a person immediately outside the building. In some cases, the controller 120 may cover the window 103 to enhance security or may uncover the window 103 to allow the outside presence to more easily identified. In another example, although information regarding the environmental conditions may be used to determine the transfer of heat through the window 103, the information may also be employed to determine when the window 103 should be covered by an exterior window covering 110 or the awning 340 should be retracted due to extremely high winds or a storm which may damage the window 103 or awning 340.

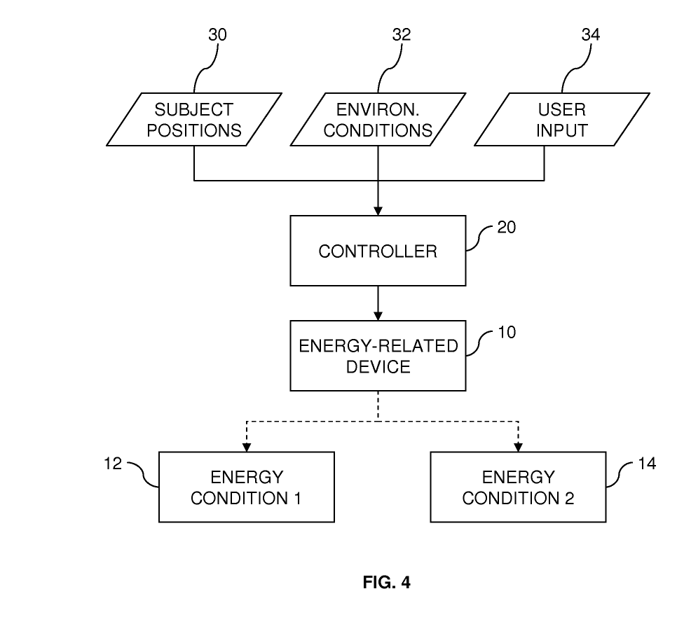

In view of the foregoing, aspects of the present invention may be more broadly described with reference to FIG. 4. In particular, the system 1 provides a controller 20 that receives inputs that may indicate both the subject positions 30 of occupants in a building and environmental conditions 32 that affect energy use within the building. In addition, the controller 20 may receive user inputs 34 that provide other thresholds, parameters, data, and user preferences to the controller 20. The inputs 30, 32, and 34 generally relate to energy use and user preferences in relation to a particular area 2, such as a room, of a building. The controller 20 processes the inputs 30, 32, and 34 according to programmed instructions, for example, stored on readable storage media. In response to the inputs 30, 32, and 34, the controller 20 operates an energy-related device 10 that determines at least a first energy condition 12 and a second energy condition 14.

The first energy condition 12 may correspond with a more efficient use of energy within the area 2, while the second energy condition 14 may correspond with a less efficient use of energy within the area 2. The energy-related device 10 is operable to determine, or modify, the energy condition in the area 2. Although energy efficiency may be better served by the energy condition 12, the controller 20 may operate the energy-related device 10 to provide energy condition 14 to meet user preferences. Accordingly, the system 1 provides an intelligent approach to accommodating both energy efficiency goals and occupant lifestyle.

Although the window covering 110 or the awning 340 provide examples of an energy-related device 10, the energy-related device 10 may be any device that relates to the consumption or conservation of energy. Indeed, while the window covering 110 or the awning 340 may aid in the conservation of energy, the energy-related device may be an appliance, such as a television or a lamp sound system that consumes energy. As such, the first energy condition for the appliance may be correspond to turning the appliance off, while the second energy condition may correspond to turning the appliance on. Thus, in this example, the controller 20 may automatically turn the appliance on when an occupant is in the area and may turn the appliance automatically off when no occupant remains in the area.

All or a portion of the devices and subsystems of the examples described herein, including the controller 20 and 120, can be implemented using one or more general purpose computer systems, microprocessors, digital signal processors, micro-controllers, smart phones, personal data assistants (PDA's), and the like, programmed according to the teachings of the exemplary embodiments of the present inventions, as is appreciated by those skilled in the computer and software arts. Appropriate software can be readily prepared by programmers of ordinary skill based on the teachings of the exemplary embodiments, as is appreciated by those skilled in the software art. Further, the devices and subsystems of the exemplary embodiments can be implemented in networked environments, such as the Internet. In addition, the devices and subsystems of the exemplary embodiments can be implemented by the preparation of application-specific integrated circuits or by interconnecting an appropriate network of conventional component circuits, as is appreciated by those skilled in the electrical art(s). Thus, the exemplary embodiments are not limited to any specific combination of hardware circuitry and/or software. Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

The embodiments described herein can also include computer readable media or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present invention has been described in connection with a number of exemplary embodiments, and implementations, the present inventions are not so limited, but rather cover various modifications, and equivalent arrangements.

What is claimed is:

1. A system for controlling energy-related characteristics of a building, comprising:
at least one energy-related device that determines a first energy-related condition and a second energy-related condition in a specified interior area of a building, the first energy-related condition corresponding to a use of energy that has a greater efficiency than the second energy-related condition;
at least one information source providing information relating to the use of the at least one energy-related device; and
a controller coupled to the at least one energy-related device and receiving the signal from the at least one sensor, the controller operating the at least one energy-related device to transition between the first energy-related condition and the second energy-related condition according to the signal from the at least one sensor and at least one user-specified input.

2. The system according to claim 1, wherein the at least one information source includes at least one sensor providing a signal indicating information relating to the use of the at least one energy-related device.

3. The system according to claim 2, wherein the at least one sensor includes at least one subject sensor providing a subject-sensor signal indicating a position of at least one subject relative to the specified interior area, and the controller operates the at least one energy-related device according to the position of the at least one subject.

4. The system according to claim 3, wherein the at least one sensor includes at least one of a motion sensor, a heat sensor, a tactile sensor, a pressure sensor, a camera, and an electrically detectable identification tag.

5. The system according to claim 3, wherein the subject-sensor signal indicates that the position of the at least one subject is in, or proximate to, the specified interior area, and the controller operates the at least one energy-related device to transition from the first energy-related condition to the second energy-related condition.

6. The system according to claim 3, wherein the subject-sensor indicates that the position of the at least one subject is remote from the specified interior area, and the controller operates the at least one energy-related device to transition from second energy-related condition to the first energy-related condition.

7. The system according to claim 1, wherein the at least one energy-related device includes an electromechanical device that responds automatically to electrical signals from the controller.

8. The system according to claim 1, wherein the at least one energy-related device is operable to provide a barrier that determines heat transfer between the specified interior area and an exterior area of the building.

9. The system according to claim 8, wherein the controller determines a temperature difference between the specified interior area and the exterior area, and the controller operates the at least one energy-related device according to the temperature difference.

10. The system according to claim 1, wherein the at least one energy-related device is operable to provide a barrier that determines heat transfer through a window.

11. The system according to claim 10, wherein the at least one energy-related device is a window covering that is operable to cover or uncover the window.

12. The system according to claim 11, wherein the user-specified input indicates when the controller covers or uncovers the window regardless of the signal from the at least one sensor.

13. The system according to claim 1, wherein the user-specified input indicates a desired temperature parameter, and the controller operates the at least one energy-related device to maintain an interior temperature of the specified interior area at the desired temperature parameter.

14. The system according to claim 2, wherein the at least one sensor includes at least one environmental sensor providing an environmental-sensor signal indicating an environmental condition related to the specified interior area of the building, and the controller operates the at least one energy-related device according to the environment-sensor signal from the at least one environmental sensor.

15. The system according to claim 14, wherein the at least one environmental sensor includes at least one of an interior temperature sensor corresponding to the specified interior area of the building and an exterior temperature sensor corresponding to an exterior area of the building.

16. The system according to claim 14, wherein the at least one environmental sensor includes a light sensor detecting sunlight directed at a window of the specified interior area, and the controller operates the at least one energy-related device to block at least partially the sunlight from the window.

17. The system according to claim 14, wherein the at least one energy-related device is an awning that is operable to extend and retract over the window.

18. The system according to claim 14, wherein the at least one energy-related device is operable to block the sunlight incrementally according to a position of the sun relative to the window.

19. The system according to claim 14, wherein at least one environmental sensor includes at least one of a temperature sensor, a light sensor, and a wind sensor.

20. The system according to claim 1, wherein the at least one energy-related device includes at least one of a window covering, an awning, and an electrically activated window tinting.

21. The system according to claim 1, wherein the at least one user input includes at least one of a threshold, parameters, data, and user preferences relating to the at least one energy-related device.

22. The system according to claim 1, wherein the at least one energy-related device includes an energy-consuming appliance that is turned on and off, the first energy-related condition corresponding to when the appliance is turned off and the second energy-related condition corresponding to when the appliance is turned on.

23. The system according to claim 1, wherein the at least one information source includes a repository preloaded with information relating to the use of the at least one energy-related device.

24. The system according to claim 1, wherein the at least one information source includes a service on a network that monitors and reports information relating to the use of the at least one energy-related device.

25. The system according to claim 1, wherein the at least one user-specified input is a device that is manually operated by at least one subject and indicates a position of the at least one subject relative to the specified interior area, and the controller operates the at least one energy-related device according to the position of the at least one subject.

26. A method for controlling energy-related characteristics of a building, comprising:
receiving information relating to the use of at least one energy-related device, the at least one energy-related device determining a first energy-related condition and a second energy-related condition in a specified interior area of a building, the first energy-related condition corresponding to a use of energy that has a greater efficiency than the second energy-related condition;
receiving at least one user-specified input relating to the use of at least one energy-related device; and
operating the at least one energy-related device to transition between the first energy-related condition and the second energy-related condition according to the received information and the user-specified preference.

27. The method according to claim 26, wherein receiving information relating to the use of at least one energy-related device includes receiving a signal from at least one sensor.

28. The method according to claim 27, wherein the at least one sensor includes at least one subject sensor providing a subject-sensor signal indicating a position of at least one subject relative to the specified interior area, and the at least one energy-related device is operated according to the position of the at least one subject.

29. The method according to claim 28, wherein the at least one sensor includes at least one of a motion sensor, a heat sensor, a tactile sensor, a pressure sensor, a camera, and an electrically detectable identification tag.

30. The method according to claim 28, wherein the subject-sensor signal indicates that the position of the at least one subject is in, or proximate to, the specified interior area, and the at least one energy-related device is operated to transition from the first energy-related condition to the second energy-related condition.

31. The method according to claim 28, wherein the subject-sensor indicates that the position of the at least one subject is remote from the specified interior area, and the at least one energy-related device is operated to transition from second energy-related condition to the first energy-related condition.

32. The method according to claim 26, wherein operating the at least one energy-related device includes automatically sending electrical signals to an electromechanical device of the at least one energy-related device.

33. The method according to claim 26, wherein the at least one energy-related device is operable to provide a barrier that determines heat transfer between the specified interior area and an exterior area of the building.

34. The method according to claim 33, wherein further comprising determining a temperature difference between the specified interior area and the exterior area, wherein the at least one energy-related device is operated according to the temperature difference.

35. The method according to claim 26, wherein the at least one energy-related device is operable to provide a barrier that determines heat transfer through a window.

36. The method according to claim 35, wherein the at least one energy-related device is a window covering that is operable to cover or uncover the window.

37. The method according to claim 36, wherein the user-specified input indicates when the controller covers or uncovers the window regardless of the signal from the at least one sensor.

38. The method according to claim 26, wherein the user-specified input indicates a desired temperature parameter, and the at least one energy-related device is operated to maintain an interior temperature of the specified interior area at the desired temperature parameter.

39. The method according to claim 27, wherein the at least one sensor includes at least one environmental sensor providing an environmental-sensor signal indicating an environmental condition related to the specified interior area of the building, and the at least one energy-related device is operated according to the environment-sensor signal from the at least one environmental sensor.

40. The method according to claim 39, wherein the at least one environmental sensor includes at least one of an interior temperature sensor corresponding to the specified interior area of the building and an exterior temperature sensor corresponding to an exterior area of the building.

41. The method according to claim 39, wherein the at least one environmental sensor includes a light sensor detecting sunlight directed at a window of the specified interior area, and the at least one energy-related device is operated to block at least partially the sunlight from the window.

42. The method according to claim 39, wherein the at least one energy-related device is an awning that is operable to extend and retract over the window.

43. The method according to claim 39, wherein the at least one energy-related device is operable to block the sunlight incrementally according to a position of the sun relative to the window.

44. The method according to claim 39, wherein at least one environmental sensor includes at least one of a temperature sensor, a light sensor, and a wind sensor.

45. The method according to claim 26, wherein the at least one energy-related device includes at least one of a window covering, an awning, and an electrically activated window tinting.

46. The system according to claim 26, wherein the at least one user input includes at least one of a threshold, parameters, data, and user preferences relating to the at least one energy-related device.

47. The method according to claim 26, wherein the at least one energy-related device includes an energy-consuming appliance that is turned on and off, the first energy-related condition corresponding to when the appliance is turned off and the second energy-related condition corresponding to when the appliance is turned on.

48. The system according to claim 26, wherein receiving information relating to the use of at least one energy-related device includes receiving the information from a repository preloaded with information relating to the use of the at least one energy-related device.

49. The system according to claim 26, wherein receiving information relating to the use of at least one energy-related device includes receiving the information from a service on a network that monitors and reports information relating to the use of the at least one energy-related device.

50. The system according to claim 26, wherein receiving the at least one user-specified input includes receiving a signal from a device that is manually operated by at least one subject and indicates a position of the at least one subject relative to the specified interior area, and the controller operates the at least one energy-related device according to the position of the at least one subject.
